(19) United States
(12) Patent Application Publication
(10) Pub. No.: US 2003/0232936 A1
(43) Pub. Date: Dec. 18, 2003

(54) Enhanced polymerization reactions based on use of special methylaluminoxane compositions

(76) Inventors: William R. Beard, Baton Rouge, LA (US); Noel H. Brantley, Baton Rouge, LA (US); Andrew Timothy Stoll, Baton Rouge, LA (US)

Correspondence Address: Mr. Philip M. Pippenger, Patent & Trademark Division, Albemarle Corporation, 451 Florida Street, Baton Rouge, LA, 70801-1765, US

(21) Appl. No.: 09/925,865

(22) Filed: Aug. 9, 2001

Related U.S. Application Data
(63) Continuation-in-part of application No. 09/739,052, filed on Dec. 15, 2000, now Pat. No. 6,518,445.

(51) Int. Cl. C08F 4/02

(52) U.S. Cl. 526/124.1; 526/348; 526/160; 526/943; 502/103; 502/117; 502/152; 502/132

(57) ABSTRACT

Polymerization of olefin monomers is conducted using at least one d- or f-block metal-containing olefin polymerization catalyst compound or complex and a novel methylaluminoxane composition (MAOC) which is a solid at 25° C. that has a total aluminum content of about 39 to 47 wt %. The MAOC is either free of aluminum as trimethylaluminum (TMA) or if TMA is present, not more than about 30 mole % of the total aluminum in the MAOC is TMA. In the solid state the MAOC contains no more than about 7500 ppm (wt/wt) of aromatic hydrocarbon. The cryoscopic number average molecular weight of MAOC as determined in benzene is at least about 1000 amu, and the MAOC has sufficient solubility in n-heptane at 25° C. to provide a solution containing 4 to as high as 7.5 wt % or more of dissolved aluminum. By vacuum distilling a solution of ordinary MAO in aromatic hydrocarbon long enough under proper conditions, MOAC is formed.

### REFERENCE TO RELATED APPLICATION

This is a continuation-in-part of commonly-owned U.S. application Ser. No. 09/739,052, filed Dec. 15, 2000, all disclosure of which including the claims thereof is incorporated herein by reference.

### TECHNICAL FIELD

This invention relates to the provision of novel methylaluminoxane compositions, to especially useful solutions of such methylaluminoxanes in hydrocarbon solvents other than aromatic hydrocarbon solvents, to the preparation of such compositions and solutions, and to use of such methylaluminoxane compositions in catalytic polymerization reactions.

In the ensuing description and in the claims hereof, reference is sometimes made to solubility in n-heptane because this is a typical, representative saturated hydrocarbon which serves as a very convenient point of reference for comparisons of solubility. However, such references to n-heptane does not constitute a limitation or restriction on the scope of this invention as regards hydrocarbons used, as the invention produces methylaluminoxane compositions that have improved solubility in a variety of liquid aliphatic and cycloaliphatic hydrocarbons as compared to the solubility of previously reported methylaluminoxane in the same respective hydrocarbons.

### BACKGROUND

Hydrocarbylaluminoxanes complexed with transition metal compounds are known to be effective olefin polymerization catalysts. See for example, U.S. Pat. No. 3,242,099 to Manyik et al. Methylaluminoxanes prepared by partial hydrolysis of trimethylaluminum under various conditions are commonly-used effective co-catalyst components. However as is well known, methylaluminoxanes have been found to have poor solubility in non-aromatic hydrocarbon solvents. See in this regard, U.S. Pat. No. 4,960,878 to Crapo et al.; U.S. Pat. No. 5,041,584 to Crapo et al.; U.S. Pat. No. 5,066,631 to Sangokoya et al.; U.S. Pat. No. 5,308,815 to Sangokoya; U.S. Pat. No. 5,847,177 to Sangokoya et al.; U.S. Pat. No. 6,001,766 to Kissin et al., and Japan Kokai 01/258,686 to Kioka et al.

Disclosures from which it is possible to calculate or at least estimate total aluminum concentrations in non-aromatic solvents include U.S. Pat No. 4,530,914 to Ewen et al.; U.S. Pat. No. 4,544,762 to Kaminsky et al.; U.S. Pat. No. 4,701,432 to Welborn; 4,752,597 to Turner; U.S. Pat. No. 4,791,180 to Turner; and U.S. Pat. No. 5,066,631 to Sangokoya et al.; and Ott, University of Hamburg Thesis, 1999. It appears that the highest reported total aluminum concentration in these documents is 3.85 wt % in heptane—see Example 3 of U.S. Pat. No. 5,066,631 to Sangokoya et al. It appears from an abstract of a paper by Matthias Ott, entitled Optimization of Methylaluminoxane Preparation, Fortschr.-Ber. VDI Reihe3 (1999),627, I-III, V-XVI, 1-137 (Accession number 2000:106460 CAPLUS) that it is speculated that it will be possible to prepare methylaluminoxane solutions of up to 10% in heptane with the use of the “Eisbandreaktor” referred to therein.

The poor solubility of methylaluminoxanes (MAO) in non-aromatic solvents is most unfortunate because polyolefin manufacturers of products that come into contact with foodstuffs desire to minimize as much as possible, if not eliminate, aromatic hydrocarbons from the raw materials and processing operations used. The manufacturers would much prefer raw materials and operations in which less toxic non-aromatic hydrocarbons are employed.

Considerable past efforts have been devoted to various ways of modifying methylaluminoxanes in order to increase their solubility in non-aromatic hydrocarbons. These efforts generally involve either the addition or inclusion of other components to improve such solubility, or the treatment of the methylaluminoxane in such a way that a substantial portion of methylaluminoxane, e.g., at least 25 percent by weight of the total methylaluminoxane on a dry basis, exists or remains as a precipitate and is not included in the solution. Such precipitates are believed to be composed of higher molecular weight oligomers and are isolated by filtration, decantation, or other liquid-solids physical separation procedure. Whatever their makeup, such precipitates are usually discarded as waste, thereby leaving in solution a lower molecular weight methylaluminoxane fraction which generally contains more than about 30 mole percent trimethylaluminum and is more soluble in non-aromatic solvents. A number of examples of such approaches are described in the patent literature.

Polymerization reactions using metallic catalysts complexed with and/or activated by conventional methylaluminoxane co-catalysts such as are currently available commercially, while satisfactory, do possess shortcomings. Firstly, as indicated above, the low solubility of such methylaluminoxanes in non-aromatic hydrocarbons is a drawback. Thus typically methylaluminoxanes are furnished to the polymer producer as solutions in an aromatic hydrocarbon such as toluene. Secondly, for good activation, relatively high proportions of the conventional methylaluminoxane co-catalysts relative to the transition, actinide, or lanthanide metal catalyst component are typically required. For example, for optimal activity an aluminum to metallocene ratio of greater than about 1000:1 is typically required for effective homogeneous olefin polymerization. According to Brintzinger, et al., Angew. Chem. Int. Ed. Engl., 1995, 34 1143-1170:

“Catalytic activities are found to decline dramatically for MAO concentrations below Al:Zr ratio roughly 200-300:1. Even at Al:Zr ratios greater than 1000:1 steady state activities increase with rising MAO concentrations approximately as the cube root of the MAO concentration”.

It would be of considerable advantage if a way could be found of providing new methylaluminoxane compositions having superior solubility characteristics in various non-aromatic hydrocarbons, especially paraffinic and cycloparaffinic hydrocarbons, without need for (a) addition or inclusion of other components to improve such solubility, or (b) treatment of the methylaluminoxane in such manner that results in loss of a substantial portion of its original content. It would also be of considerable advantage if a way could be found of improving transition, actinide, and/or lanthanide metal-catalyzed polymerization reactions using new methylaluminoxane compositions having superior solubility characteristics. Another advantage, if it could be achieved, would be the provision of new methylaluminoxane compositions that have superior solubility characteristics, and that can be introduced into the polymerization reactor or zone in the form of solids, or in the form of solutions or slurries in any of a variety of suitable solvents, including non-aromatic hydrocarbon solvents.

### THE INVENTION

This invention involves, inter alia, the discovery that it is indeed possible to form and provide such new methylaluminoxane compositions having significantly higher solubility in non-aromatic hydrocarbons without addition of any third component to increase solubility, and without recourse to processing that removes substantial portions of higher molecular weight components from the methylaluminoxane. In addition, this invention makes it possible to improve transition, actinide, and/or lanthanide metal-catalyzed polymerization reactions using new methylaluminoxane compositions having superior solubility characteristics. Also, this invention makes it possible to provide new methylaluminoxane compositions that have superior solubility characteristics, and that can be introduced into the polymerization reactor or zone in the form of solids, or in the form of solutions or slurries in any of a variety of suitable solvents, including non-aromatic hydrocarbon solvents.

Accordingly, in one of its embodiments this invention provides a methylaluminoxane composition wherein:

A) the composition is a solid at 25° C.;

B) the composition has a total aluminum content in the range of about 39 to about 47 wt % based on the total weight of the composition in the solid state;

C) the composition is either free of aluminum in the form of trimethylaluminum or if trimethylaluminum is present in the composition, not more than about 30 mole %, preferably no more than about 20 mole %, and most preferably no more than about 10 mole % of the total aluminum present in the composition is in the form of trimethylaluminum;

D) the composition in the solid state contains no more than about 7500 ppm (wt/wt), preferably no more than about 5000 ppm (wt/wt), more preferably no more than about 2000 ppm (wt/wt), still more preferably no more than about 1000 pm (wt/wt), and even more preferably no than about 100 ppm (wt/wt) of aromatic hydrocarbon.

E) the cryoscopic number average molecular weight of the composition as determined in benzene is at least about 1000, preferably at least about 1100, and more preferably at least about 1200 atomic mass units; and

F) the composition has sufficient solubility in n-heptane at 25° C. to provide a solution containing at least 4 wt %, preferably at least 5 wt %, and most preferably at least 7.5 wt % of dissolved aluminum.

Preferably, these solid state methylaluminoxane compositions not only meet each of the above requirements A) through F), but in addition are in a freely flowably particulate or powder form, the average particle size and particle size distribution being of no concern so long as the particles are freely flowable and are not so large as to plug up or not pass through ordinary feeding apparatus such as hoppers or solids feed lines.

Another embodiment of this invention is a method of preparing the above methylaluminoxane compositions. The method comprises subjecting a solution of methylaluminoxane in an aromatic hydrocarbon solvent to distillation at a temperature no higher than about 25° C. under reduced pressure of below 1×10⁻⁵ millimeters of mercury to form a solid methylaluminoxane composition that complies with each of the criteria set forth above as A) through F), inclusive.

A further embodiment of this invention is a slurry, and preferably a solution, formed from (i) a solid methylaluminoxane composition that complies with each of the criteria set forth above as A) through F), inclusive, and (ii) a liquid hydrocarbon, preferably a liquid non-aromatic hydrocarbon.

Pursuant to another embodiment of this invention there is provided a composition which comprises a solution of methylaluminoxane in a non-aromatic hydrocarbon solvent, wherein:

a) if any trimethylaluminum is present in the solution, no more than about 30 mole %, preferably no more than about 20 mole %, and more preferably no more than about 10 mole % of the total dissolved aluminum in the solution is trimethylaluminum;

b) the solution has a total dissolved aluminum content above 4 wt %, preferably 5 wt % or more, and more preferably at least about 7.5 wt %, based on the total weight of all dissolved aluminum components of the methylaluminoxane plus the weight of the non-aromatic hydrocarbon solvent;

c) the solution contains, if any, no more than about 7500 ppm (wt/wt), preferably no more than about 5000 ppm (wt/wt), and more preferably no more than about 2000 ppm (wt/wt), of aromatic hydrocarbon, based on the total weight of all dissolved aluminum components of the methylaluminoxane plus the total weight of the hydrocarbon solvent (i. e., including the weight of the aromatic hydrocarbon, if any, in the solution); and

d) the methylaluminoxane used in forming the solution has a cryoscopic number average molecular weight as determined in benzene of at least 1000, more preferably at least 1100, and most preferably at least 1200 atomic mass units.

In still more preferred embodiments the foregoing solution has, if any, a content of aromatic hydrocarbon solvent of no more than about 1000 ppm (wt/wt) and even more preferably such content is no more than about 100 ppm (wt/wt).

Still other embodiments of this invention are methods of preparing the compositions of the immediately preceding paragraph. One such method comprises subjecting a solution of methylaluminoxane in an aromatic hydrocarbon solvent to distillation at a temperature no higher than about 30° C., and preferably no higher than about 25° C., under reduced pressure of about 1×10⁻⁵ millimeters of mercury or less to form a solid methylaluminoxane residue that has (i) an aluminum content in the range of about 39 to about 47 wt %, (ii) a trimethylaluminum content, if any, of no more than about 30 mole %, preferably no more than about 20 mole %, and more preferably no more than about 10 mole % of the total aluminum content of the residue, and (iii) a cryoscopic number average molecular weight as determined in benzene of at least 1000, more preferably at least 1100, and most preferably at least 1200 atomic mass units; and dissolving such solid methylaluminoxane residue in a non-aromatic hydrocarbon solvent in an amount such that the resultant solution contains at least 4 wt %, preferably at least about 5 wt %, and more preferably at least about 7.5 wt % of dissolved aluminum based on the weight of these specified components. Another such method comprises (i) subjecting a solution of methylaluminoxane in an aromatic hydrocarbon solvent to distillation at a temperature no higher than about 30° C., and preferably no higher than about 25° C., under reduced pressure to remove (i.e., to strip off) a portion of the aromatic hydrocarbon solvent and to form a liquid-containing residual mixture in the distillation vessel, (ii) then initiating a feed of at least one liquid non-aromatic hydrocarbon solvent into the liquid-containing residual mixture in the distillation vessel, such feed being introduced into said liquid-containing residual mixture below the surface of the liquid thereof, and (iii) continuing to remove (strip off) at least aromatic hydrocarbon solvent and optionally a portion of the non-aromatic hydrocarbon solvent until essentially all of the aromatic hydrocarbon solvent has been removed (i. e., stripped off) and a product solution of methylaluminoxane in the liquid non-aromatic hydrocarbon solvent has been formed. The content of aromatic hydrocarbon solvent, if any, remaining in such product solution should be no more than about 7500 ppm (wt/wt), preferably no more than about 5000 ppm (wt/wt), more preferably no more than about 2000 ppm (wt/wt), and still more preferably no more than about 1000 ppm (wt/wt). Most preferably the product solution contains, if any, no more than 100 ppm of aromatic hydrocarbon solvent. The entire distillation operation of this latter embodiment is performed at a reduced pressure so that the temperature of the mixture undergoing distillation does not exceed about 25° C. A process conducted in the manner of this latter embodiment is sometimes known in the art as a “solvent swap” process. Still another method is a variant of the first above method. In particular, a solution of methylaluminoxane in an aromatic solvent, typically toluene, is placed in an agitated vessel. Vacuum is applied in the 10 to 75 mmHg range to the vessel. The contents of the vessel are heated until the solution begins to boil which typically should occur at no more than about 50° C. over this pressure range. When most of the solvent (e.g., toluene) has been removed, the contents are heated up to the range of about 90-110° C. This final stage of drying at elevated temperature is continued until the level of residual aromatic hydrocarbon, e.g., toluene, has been reduced to about 7500 ppm (wt/wt) or less, preferably to about 5000 ppm (wt/wt) or less, more preferably to about 2000 ppm (wt/wt) or less, still more preferably to about 1000 pm (wt/wt) or less, and even more preferably to about 100 ppm (wt/wt) or less. It is advantageous during this final stage of drying to continually purge the vessel with a dry, inert gas, such as nitrogen, to aid in the rate of solvent removal.

The method to be used in determining the mole percentage of trimethylaluminum in the methylaluminoxane, in any case where it is desired or deemed necessary to determine such mole percentage, is identified hereinafter and is referred to in this document as the NMR Analytical Procedure. It is described in “Characterization of Methylaluminoxanes and Determination of Trimethylaluminum Using Proton NMR” by Donald W. Imhoff, Larry S. Simeral, Samuel A. Sangakoya, and James H. Peel; Organometallics, 1998, 17, 1941-1945.

A further embodiment of this invention is a polymerization process which comprises contacting at least one polymerizable olefin monomer under polymerization conditions with a catalyst composition formed from components comprising (i) at least one d- or f-block metal-containing olefin polymerization catalyst compound or complex, and (ii) a methylaluminoxane composition, wherein said methylaluminoxane composition which, when by itself in the form of solid particles or powder, meets each of the following requirements:

A) said methylaluminoxane composition does not melt or otherwise exist as a liquid when at 25° C.;

B) said methylaluminoxane composition has a total aluminum content in the range of about 39 to about 47 wt % based on the total weight of the methylaluminoxane composition in the particulate or powder form;

C) said methylaluminoxane composition is either free of aluminum in the form of trimethylaluminum or if trimethylaluminum is present in the methylaluminoxane composition, not more than about 30 mole % of the total aluminum present in the methylaluminoxane composition is in the form of trimethylaluminum;

D) said methylaluminoxane composition contains no more than about 7500 ppm (wt/wt) of aromatic hydrocarbon;

E) said methylaluminoxane composition has a cryoscopic number average molecular weight as determined in benzene of at least about 1000 atomic mass units; and

F) said methylaluminoxane composition has sufficient solubility in n-heptane at 25° C. to provide a solution containing at least 4 wt % of dissolved aluminum.

One preferred way of carrying out this polymerization process is to feed the methylaluminoxane composition meeting all of the criteria of A) through F) above into the polymerization reactor or reaction zone with the methylaluminoxane composition being in the form of particulate or powdery solids as it is being fed. Another preferred way of carrying out this polymerization process is to feed the methylaluminoxane composition meeting all of the criteria of A) through F) above into the polymerization reactor or reaction zone with the methylaluminoxane composition being in the form of a slurry or preferably in the form of a solution in a liquid hydrocarbon, and preferably in a non-aromatic liquid hydrocarbon.

A further embodiment of this invention is a method of producing an olefinic polymer which comprises polymerizing at least one polymerizable olefinic monomer with a catalyst composition formed from a transition, actinide, or lanthanide metal-containing catalyst compound and a methylaluminoxane composition of this invention. The preferred ways of feeding the methylaluminoxane composition described in the immediately preceeding paragraph can be employed in conducting this and other embodiments as well.

These and other embodiments and features of this invention will become further apparent from the ensuing description and appended claims.

### FURTHER DETAILED DESCRIPTION

New Methylaluminoxane Compositions and Their Preparation

The methylaluminoxanes (a.k.a. methylalumoxanes) components utilized as starting materials in forming the aromatic hydrocarbon solution prior to distillation are essentially the same as those made commercially in aromatic solvents (e.g. toluene). They are characterized by evolving, when subjected to hydrolysis with water, methane, as well as very small amounts of hydrogen and hydrocarbon molecules which are larger than methane, such as, for example, ethane, propane, isobutane and n-butane. These alkanes larger than methane result from impurities in the trimethylaluminum from which the methylaluminoxane is produced. No organoaluminum compound other than trimethylaluminum of typical commercial purity (e.g., 98% or more) should be used in forming or be added to the methylaluminoxane starting material.

Either of two different types of processes are usually, but not necessarily, used for producing the methylaluminoxanes used as starting materials in the practice of this invention. One such well-known process involves controlled, partial hydrolysis of trimethylaluminum with free water or with water derived from a hydrated metal salt. Processes of this type are described, for example, in U.S. Pat. Nos. 4,908,463; 4,924,018; 5,003,095; 5,041,583; 5,066,631; 5,099,050; 5,157,008; 5,157,137; 5,235,081; 5,248,801, and 5,371,260. Methylaluminoxanes typically contain varying amounts, of from about 5 to 35 mole percent, of the aluminum value as unreacted trimethylaluminum. Preferably, the aluminum content as trimethylaluminum is less than about 23 mole percent of the total aluminum value, and, more preferably, less than about 20 mole percent. The other process involves treating trimethylaluminum with a compound containing an oxygen-carbon bond such as carbon dioxide, benzoic acid, benzophenone, acetone and the like. See in this connection, U.S. Pat. No. 5,831,109, entitled “Polyaluminoxane Compositions Formed by Non-Hydrolytic Means”.

Often the methylaluminoxane as produced and offered for sale in the marketplace is in the form of a solution in an aromatic hydrocarbon, typically toluene. Such solutions usually contain 10 or 30 wt % of the methylaluminoxane, and it is convenient (but of course not necessary) to use such solutions in preparing the new methylaluminoxane compositions of this invention.

A solution of the conventional methylaluminoxane in an aromatic hydrocarbon solvent is subjected to distillation under reduced pressure conditions at a temperature no higher than about 30° C. for a period of time long enough not only to remove the liquid phase but to produce a solid product satisfying the above criteria of A) through F) inclusive. Preferably the distillation is performed at ambient room temperature, e.g., at temperatures in the vicinity of 25° C. The pressure during distillation is maintained below about 1×10⁻⁵ millimeters of mercury, with a pressure of less than about 5×10⁻⁶ millimeters of mercury being more desirable. The time period for the vacuum distillation will of course vary depending upon such factors as the concentration of the initial solution of the methylaluminoxane, the aromatic hydrocarbon used as the solvent for such solution, and the reduced pressure employed. Times in the range of about 4 to about 120 hours may suffice, but in any case where suitable or optimal time-temperature-pressure conditions for any given initial aromatic hydrocarbon solution of methylaluminoxane have not been previously ascertained, a few pilot experiments on a laboratory scale coupled with product analyses and evaluations will enable determination of conditions to be used. Examples 1 and 2 hereinafter provide conditions known to be very satisfactory with the methylaluminoxane solutions used therein.

It will of course be understood that the process of preparing a methylaluminoxane of this invention should be conducted under suitably inert and anhydrous conditions.

The solid methylaluminoxane composition of this invention is the residue formed upon distillation, and thus it has an aluminum content in the range of from about 39 to about 47 wt %, and more preferably in the range of from about 41 to about 45 wt %. Most preferable is an aluminum content in the range of from about 42 to about 44 wt %. Usually the solid methylaluminoxane composition will contain some trimethylaluminum, and when it does, not more than 30 mole %, preferably no more than 20 mole %, and more preferably no more than 10 mole % of the aluminum in the composition is in the form of trimethylaluminum, all as determined by the aforementioned NMR Analytical Procedure. The content, if any, of aromatic hydrocarbon in the compositions of this invention may also conveniently be determined by proton NMR spectroscopy using the aforementioned published NMR Analytical Procedure. In the event of disparate results from different methods of determining the aromatic hydrocarbon content of such compositions, the value as determined by such published NMR procedure should control. The cryoscopic molecular weight of the composition is determined by using benzene, rather than 1,4-dioxane, as the cryoscopic solvent in the procedure described in “Determination of Trimethylaluminum and Characterization of Methylaluminoxanes Using Proton NMR” by Donald W. Imhoff, Larry S. Simeral, Don R. Blevins, and William R. Beard; ppg 177-191 of ACS Symposium Series 749, Olefin Polymerization: Emerging Frontiers; Palanisamy Arjunan, James E. McGrath, and Thomas L. Hanlon, Eds.; copyright 2000 by the American Chemical society, Washington, D.C.

Solutions of this Invention and Their Formation

To form the solutions of this invention one either (i) prepares a solid methylaluminoxane of this invention and dissolves all or a portion of such composition in a suitable non-aromatic hydrocarbon solvent, or (ii) if a solid composition of this invention has already been prepared and provided for use, all or a portion of such composition is used in preparing a solution of this invention, or (iii) the methylaluminoxane solution may be prepared directly in the non-aromatic solvent, that is, by reacting trimethylaluminum with a suitable reagent (e.g., water or benzoic acid) in the non-aromatic solvent, or (iv) the methylaluminoxane solution may be prepared by replacing essentially all of the aromatic hydrocarbon solvent in a solution of the methylaluminoxane in an aromatic hydrocarbon solvent by non-aromatic hydrocarbon solvent by a solvent swap process. Alternative (i) typically involves preparing the solid methylaluminoxane composition (reduced pressure distillation residue) at the site where the solution will be formed. Alternative (ii) typically involves preparing a solid composition of this invention at a plant site which is not necessarily the site at which the solution of this invention will be prepared. In this second case one preparing the solution will typically purchase the solid methylaluminoxane of this invention from the manufacturer thereof. Thus the overall process of this invention (making and dissolving) can be conducted by one party typically at one plant site or by two or more different parties typically at different plant sites (making at one plant site, and dissolving at another plant site). All such alternatives are within the scope of this invention.

In conducting the solvent swap process for preparing the solutions of this invention, a solution of conventional methylaluminoxane in an aromatic hydrocarbon solvent is subjected to distillation under reduced pressure conditions at a temperature no higher than about 30° C., and preferably no higher than about 25° C., for a period of time long enough to remove (i. e., to strip off) a portion of the liquid phase to leave an enriched methylaluminoxane solution or slurry in the residual liquid aromatic hydrocarbon solvent. At this point, a feed of mon-aromatic hydrocarbon solvent is initiated so that the non-aromatic hydrocarbon solvent is introduced below the surface of the enriched methylaluminoxane solution or slurry. Reduced pressure distillation is continued whereby additional aromatic hydrocarbon solvent, optionally along with a portion of the non-aromatic hydrocarbon solvent, is removed (i.e., stripped off). Such distillation is continued until a solution of this invention has been formed.

Any saturated or unsaturated non-aromatic hydrocarbon, mixture of two or more saturated hydrocarbons, mixture of two or unsaturated non-aromatic hydrocarbons, or mixture of one or more saturated and one or more unsaturated non-aromatic hydrocarbons that exists as a liquid at least throughout the range of about 20 to about 30° C. can be used as the solvent in the hydrocarbon solutions of this invention. Preferred hydrocarbon solvents of this type used in the practice of this invention include (a) one or more alkane, alkene, alkadiene, cycloalkane, cycloalkene, cycloalkadiene, or alkyne hydrocarbons, that exist as a liquid at least throughout the range of about 20 to about 30° C.; or (b) a mixture of at least two of (a); or (c) at least one of (a) and/or (b), and one or more alkane hydrocarbons that exist as a liquid at least throughout the range of about 20 to about 30° C. A few non-limiting examples of such hydrocarbons include n-pentane, isopentane, cyclopentane, 1-pentene, 2-pentene, n-hexane, 2-methylpentane, 3-methylpentane, cyclohexane, 1-hexene, 2-hexene, 3-hexene, cyclohexene, 1,5-hexadiene. methylcyclohexane, n-heptane, 2-methylheptane, 3-methylheptane, 4-methylheptane, 1-heptyne, 2-heptyne, 3-heptyne, n-octane, 1-octene, octadiene, 2,2,4-trimethylpentane, 1,3,5,7-cyclooctatetraene, n-nonane, n-decane, 1-decene, 1-decyne, 5-decyne, α-pinene, decahydronaphthalene, n-dodecane, and pentadecane.

If trimethylaluminum is present in the methylaluminoxane solutions of this invention, no more than about 30 mole % of the total dissolved aluminum should be present as trimethylaluminum. It is more desirable that no more than 20 mole %, and still more desirable that no more than 10 mole % of the total dissolved aluminum be present as trimethylaluminum, as determined by the aforementioned NMR Analytical Procedure.

Typically, the methylaluminoxane solution has a total dissolved aluminum content above about 4 wt % and more preferably above about 5 wt %. Most preferable is a total dissolved aluminum content which is above about 7.5 wt %. The total dissolved aluminum content is based on the total weight of all dissolved aluminum species which are components of the methylaluminoxane plus the weight of the non-aromatic hydrocarbon solvent. Thus when forming the methylaluminoxane solution from a solid methylaluminoxane of this invention (e.g., a reduced pressure distillation residue), the solid methylaluminoxane is dissolved in a non-aromatic hydrocarbon solvent in amounts such that the methylaluminoxane solution produced contains an amount of dissolved aluminum in accordance with the foregoing. Of course if one wishes to do so, the amount of the solid methylaluminoxane of this invention dissolved in a non-aromatic hydrocarbon solvent can be less than about 4 wt %. Alternatively when forming a methylaluminoxane solution of this invention by means of a solvent swap procedure, the proportions of the components used are adjusted so as to produce a solution of this invention containing an amount of dissolved aluminum as described above. Here agin it is possible, if one wishes to do so, to form a more dilute solution of the methylaluminoxane of this invention in an essentially non-aromatic hydrocarbon solvent.

The methylaluminoxane solutions of this invention contain, if any, no more than about 7500 ppm (wt/wt), and preferably no more than about 5000 ppm (wt/wt). Still more preferably these solutions contain no more than about 2000 ppm (wt/wt) of aromatic hydrocarbon, and even more preferably no more than about 1000 ppm (wt/wt). It is particularly preferred that the solutions of this invention contain no more than about 500 ppm, and most preferably no more than about 100 ppm, of aromatic hydrocarbon. The indicated ppm determinations are based upon the total weight of all dissolved aluminum species which are components of the solid methylaluminoxane composition plus the total weight of the hydrocarbon solvent, including aromatic solvent components, if any.

The cryoscopic number average molecular weight, as determined in benzene solution, of the methylaluminoxane in solution is at least about 1000 atomic mass units (amu), preferably above about 1100 amu, and most preferably above about 1200 amu.

When the methylaluminoxane compositions and solutions of this invention are hydrolyzed, whether in solid form or in solution, the non-methane hydrocarbon hydrolysis products are the same as those formed from hydrolysis of commercial grades of trimethylaluminum and commercial grades of aromatic-solvent solutions of methylaluminoxanes in that the non-methane hydrocarbon hydrolysis products contain, if any, no more than about 2 mole percent of other hydrocarbons formed during the hydrolysis reaction. Furthermore, they contain essentially no detectable amount of any other hydrocarbon except perhaps at most 7500 ppm (wt/wt) of trace residual amounts of aromatic hydrocarbon (usually toluene) in which the methylaluminoxane had been dissolved before being isolated from such solution. Thus the methylaluminoxane solutions of the present invention are “all-methyl aluminoxanes” in that they have been produced from trimethylaluminum of standard commercial purity, and no other organoaluminum compound has been added either to the trimethylaluminum used in forming the methylaluminoxane, or to the methylaluminoxane itself. The traces of vaporous hydrocarbon(s) typically, but not necessarily, released on aqueous hydrolysis of the methylaluminoxane probably result from trace amounts of impurities present in the original trimethylaluminum used as the starting material for producing the methylaluminoxane.

The following Examples are presented for purposes of illustration and are not intended to limit, do not limit, and should not be construed as limiting, the generic scope of this invention.

Examples 1 and 2 illustrate methods of producing solid methylaluminoxanes pursuant to this invention.

### EXAMPLE 1

A 30 wt % methylaluminoxane (MAO) in toluene solution, which was produced in a commercial plant by the direct hydrolysis of trimethylaluminum with free water, was vacuum stripped to dryness at ambient temperatures in the range of 18 to 27° C. at pressures as low as about 1×10⁻⁶ millimeters of mercury for sixteen days. A friable, white solid MAO product was obtained which, when subjected to the above NMR Analytical Procedure, was found to contain 8.59 mole % of trimethylaluminum, and 0.52 wt % of toluene. The aluminum content of the product, determined by acid digestion followed by EDTA titration, was 42.81 wt %; and its number average molecular weight, determined by cryoscopy in benzene solvent, was 1593 atomic mass units (amu).

### EXAMPLE 2

In a nitrogen atmosphere, 740 grams of toluene and 113.2 grams of trimethylaluminum were heated to 50° C. To this solution was added 77.0 grams of ferrous sulfate heptahydrate in four equal increments over a two-hour period. The solution was kept at 50° C. for an additional 6 hours. Solids were removed by centrifugation, leaving a clear supernatant liquid containing 3.42 wt % aluminum. NMR analysis indicated the formation of a methylaluminoxane. A portion of the supernatant solution was vacuum stripped to dryness for approximately 6 hours at 1×10⁻⁵ (i.e., 0.00001) millimeters of mercury and at ambient temperatures in the range of about 18 to 27° C.

The friable, white solid MAO product, when subjected to the above NMR Analytical Procedure, was found to contain 12 mole % of trimethylaluminum and 0.3 wt % toluene. The aluminum content of the product, determined by acid digestion followed by EDTA titration, was 42.3 wt %; and its number average molecular weight, determined by cryoscopy in benzene solvent, was 1166 amu.

Examples 3-20 illustrate the solubility of MAO in various hydrocarbon solvents formed from 30 wt % slurries of MAO.

### EXAMPLES 3-20

In a nitrogen atmosphere at ambient temperatures, individually weighed portions of solid MAO from either Example 1 or Example 2 were combined with various aliphatic hydrocarbons in proportions such that slurries containing 30 wt % MAO were formed. After thorough mixing, the solid MAO which did not dissolve was collected by centrifugation and dried. The amount of MAO that dissolved was obtained by taking the difference between the amount of MAO initially added and the amount of solvent-free solid MAO that had centrifuged out of the solution. The amount of MAO centrifuged out of solution was determined by vacuum removal of any traces of solvent and weighing of the resultant solvent-free solid. Table I sets forth the weight percentage of the solid MAO that dissolved in each respective solvent and the weight percentage of aluminum present in each of the respective solutions.

TABLE I

| | | Amount | | Calculated | | | Wt % | | | | |
|---|---|---|---|---|---|---|---|---|---|---|---|
| | | (wt %) of | Calculated | wt % | Calculated | Calculated | Aluminum | | | | |
| | | Solid | wt % | Aluminum | Mole % | wt % | in Solution | Source | | Mole % | Wt % |
| | | MAO | MAO in | in | TMA in | Toluene in | Found by | of | Wt % Al | TMA in | Toluene in |
| Example | Solvent | Dissolved | Solution | Solution¹ | Solution² | Solution³ | Analysis | MAO | in MAO | MAO | MAO |
| 3 | cyclohexane | 91% | 28.1% | 12.0% | 9.44% | 0.16% | — | Ex 1 | 39.6% | 8.59% | 0.52% |
| 4 | methylcyclohexane | 94% | 28.7% | 12.3% | 9.14% | 0.16% | 12.8% | Ex 1 | 39.6% | 8.59% | 0.52% |
| 5 | methylcyclohexane | 93% | 28.5% | 12.1% | 12.90% | 0.09% | — | Ex 2 | 42.3% | 12.0% | 0.30% |
| 6 | pentane | 67% | 22.3% | 9.6% | 12.82% | 0.17% | — | Ex 1 | 39.6% | 8.59% | 0.52% |
| 7 | hexane | 67% | 22.3% | 9.6% | 12.82% | 0.17% | — | Ex 1 | 39.6% | 8.59% | 0.52% |
| 8 | hexane | 78% | 25.1% | 10.6% | 15.38% | 0.10% | — | Ex 2 | 42.3% | 12.0% | 0.30% |
| 9 | heptane | 63% | 21.3% | 9.1% | 13.63% | 0.18% | — | Ex 1 | 39.6% | 8.59% | 0.52% |
| 10 | heptane | 72% | 23.6% | 10.0% | 16.67% | 0.10% | — | Ex 2 | 42.3% | 12.0% | 0.30% |
| 11 | octane | 58% | 19.9% | 8.5% | 14.81% | 0.18% | — | Ex 1 | 39.6% | 8.59% | 0.52% |
| 12 | iso-pentane | 72% | 23.6% | 10.1% | 11.93% | 0.17% | — | Ex 1 | 39.6% | 8.59% | 0.52% |
| 13 | 3-methylpentane | 75% | 24.3% | 10.4% | 11.45% | 0.17% | — | Ex 1 | 39.6% | 8.59% | 0.52% |
| 14 | cyclopentane | 96% | 29.1% | 12.5% | 8.95% | 0.16% | 13.4% | Ex 1 | 39.6% | 8.59% | 0.52% |
| 15 | cyclopentane | 97% | 29.4% | 12.4% | 12.37% | 0.09% | — | Ex 2 | 42.3% | 12.0% | 0.30% |
| 16 | Isopar E | 61% | 20.7% | 8.9% | 14.08% | 0.18% | — | Ex 1 | 39.6% | 8.59% | 0.52% |
| 17 | Isopar G | 37% | 13.7% | 5.9% | 23.22% | 0.19% | — | Ex 1 | 39.6% | 8.59% | 0.52% |
| 18 | cycloheptane | 57% | 19.6% | 8.4% | 15.07% | 0.18% | — | Ex 1 | 39.6% | 8.59% | 0.52% |
| 19 | cyclooctane | 30% | 11.4% | 4.9% | 28.63% | 0.20% | — | Ex 1 | 39.6% | 8.59% | 0.52% |
| 20 | isohexane | 69% | 22.8% | 9.8% | 12.45% | 0.17% | — | Ex 1 | 39.6% | 8.59% | 0.52% |

¹Assumes equal aluminum contents for the soluble and insoluble portions.
²Assumes all TMA present in the solid MAO was extracted into the solution. This assumption slightly over-estimates the TMA contents of the solution.
³Assumes all toluene present in the solid was extracted into the solution.

### EXAMPLES 21-45

In a nitrogen atmosphere at ambient temperatures, individual weighed portions of solid MAO from Example 1 were combined with various olefinic hydrocarbons in proportions such that slurries containing 30 wt % MAO were formed. After thorough mixing, the solid MAO which did not dissolve was collected by centrifugation. The amount of MAO that dissolved was determined as described for Examples 3-20. Table II sets forth the weight percentage of the solid MAO that dissolved in each respective solvent and the weight percentage of aluminum present in each of the respective solutions.

TABLE II

| | | Amount | | Calculated | | |
|---|---|---|---|---|---|---|
| | | (wt %) of | Calculated | wt % | Calculated | Calculated |
| | | Solid | wt % | Aluminum | Mole % | wt % |
| | | MAO | MAO in | in | TMA in | Toluene in |
| Example | Solvent | Dissolved | Solution | Solution⁴ | Solution⁵ | Solution⁶ |
| 21 | 1-pentene | 85% | 26.7% | 11.4% | 10.11% | 0.16% |
| 22 | 1-hexene | 97% | 29.4% | 12.6% | 8.86% | 0.16% |
| 23 | 1-octene | 89% | 27.6% | 11.8% | 9.65% | 0.16% |
| 24 | 1-decene | 66% | 22.0% | 9.4% | 13.02% | 0.17% |
| 25 | 2-pentene | 72% | 23.6% | 10.1% | 11.93% | 0.17% |
| 26 | 1,4-cyclooctadiene | 94% | 28.7% | 12.3% | 9.14% | 0.16% |
| 27 | 1,5-hexadiene | 91% | 28.1% | 12.0% | 9.44% | 0.16% |
| 28 | 4-vinyl-1-cyclohexene | 91% | 28.1% | 12.0% | 9.44% | 0.16% |
| 29 | cyclohexene | 94% | 28.7% | 12.3% | 9.14% | 0.16% |
| 30 | 1,3-cyclohexadiene | 96% | 29.1% | 12.5% | 8.95% | 0.16% |
| 31 | 1-methyl-1,3-cyclohexadiene | 80% | 25.5% | 10.9% | 10.74% | 0.17% |
| 32 | cyclooctene | 89% | 27.6% | 11.8% | 9.65% | 0.16% |
| 33 | 1,3-cyclooctadiene | 95% | 28.9% | 12.4% | 9.04% | 0.16% |
| 34 | 1-tert-butyl-1-cyclohexene | 6% | 2.5% | 1.1% | >100% | 0.22% |
| 35 | 1-isopropyl-1-cyclohexene | 33% | 12.4% | 5.3% | 26.03% | 0.20% |
| 36 | 4-methyl-1-cyclohexene | 94% | 28.7% | 12.3% | 9.14% | 0.16% |
| 37 | 2,5-dimethyl-2,4-hexadiene | 94% | 28.7% | 12.3% | 9.14% | 0.16% |
| 38 | limonene | 91% | 28.1% | 12.0% | 9.44% | 0.16% |
| 39 | 4-methyl-1-hexene | 86% | 26.9% | 11.5% | 9.99% | 0.16% |
| 40 | 2,3-dimethyl-2-hexene | 34% | 12.7% | 5.4% | 25.26% | 0.19% |
| 41 | 2,5-dimethyl-1,5-hexadiene | 96% | 29.1% | 12.5% | 8.95% | 0.16% |
| 42 | 7-methyl-1,4-cyclooctadiene | 94% | 28.7% | 12.3% | 9.14% | 0.16% |
| 43 | 2-methyl-1,5-hexadiene | 96% | 29.1% | 12.5% | 8.95% | 0.16% |
| 44 | trans-3-hexene | 57% | 19.6% | 8.4% | 15.07% | 0.18% |
| 45 | 2-methyl-1-hexene | 90% | 27.8% | 11.9% | 9.54% | 0.16% |

⁴Assumes equal aluminum contents for the soluble and insoluble portions.
⁵Assumes all TMA present in the solid MAO was extracted into the solution. This assumption slightly over-estimates the TMA contents of the solution.
⁶Assumes all toluene present in the solid was extracted into the solution.
⁷The calculated amount of TMA in the solution was greater than 100%.

### EXAMPLES 46-61

In a nitrogen atmosphere at ambient temperatures, individual weighed portions of solid MAO from Example 1 were combined with various mixtures of hydrocarbons in proportions such that slurries containing 30 wt % MAO were formed. After thorough mixing, the solid MAO which did not dissolve was collected by centrifugation. The amount of MAO that dissolved was determined as described for Examples 3-20. Table III sets forth the weight percentage of the solid MAO that dissolved in each respective solvent mixture, the weight percentage of aluminum present in each of the respective solutions, and the relative amounts (wt %) of each solvent in the solvent mixture.

TABLE III

| | | | | | Amount | | Calculated | | |
|---|---|---|---|---|---|---|---|---|---|
| | | Amount of | | Amount of | (wt %) of | Calculated | wt % | Calculated | Calculated |
| | | Solvent 1 | | Solvent 2 | Solid | wt % | Aluminum | Mole % | wt % |
| | | in Solvent | | in Solvent | MAO | MAO in | in | TMA in | Toluene in |
| Example | Solvent 1 | Mixture | Solvent 2 | Mixture | Dissolved | Solution | Solution⁸ | Solution⁹ | Solution¹⁰ |
| 46 | cyclopentane | 74% | heptane | 26% | 90% | 27.8% | 11.9% | 9.54% | 0.16% |
| 47 | cyclopentane | 50% | heptane | 50% | 76% | 24.6% | 10.5% | 11.30% | 0.17% |
| 48 | cyclopentane | 25% | heptane | 75% | 61% | 20.7% | 8.9% | 14.08% | 0.18% |
| 49 | cyclopentane | 51% | methylcyclohexane | 49% | 90% | 27.8% | 11.9% | 9.54% | 0.16% |
| 50 | cyclopentane | 50% | 1-octene | 50% | 89% | 27.6% | 11.8% | 9.65% | 0.16% |
| 51 | cyclopentane | 98% | 1,4-cyclooctadiene | 2% | 90% | 27.8% | 11.9% | 9.54% | 0.16% |
| 52 | methylcyclohexane | 75% | heptane | 25% | 78% | 25.1% | 10.7% | 11.01% | 0.17% |
| 53 | methylcyclohexane | 51% | heptane | 49% | 68% | 22.6% | 9.7% | 12.63% | 0.17% |
| 54 | methylcyclohexane | 26% | heptane | 74% | 58% | 19.9% | 8.5% | 14.81% | 0.18% |
| 55 | methylcyclohexane | 50% | 1-octene | 50% | 85% | 26.7% | 11.4% | 10.11% | 0.16% |
| 56 | methylcyclohexane | 98% | 1,4-cyclooctadiene | 2% | 89% | 27.6% | 11.8% | 9.65% | 0.16% |
| 57 | heptane | 50% | 1-octene | 50% | 64% | 21.5% | 9.2% | 13.42% | 0.17% |
| 58 | heptane | 96% | 1,4-cyclooctadiene | 4% | 54% | 18.8% | 8.0% | 15.91% | 0.18% |
| 59 | heptane | 98% | 1,4-cyclooctadiene | 2% | 51% | 17.9% | 7.7% | 16.84% | 0.18% |
| 60 | heptane | 99% | 1,4-cyclooctadiene | 1% | 52% | 18.2% | 7.8% | 16.52% | 0.18% |
| 61 | 1-octene | 98% | 1,4-cyclooctadiene | 2% | 74% | 24.1% | 10.3% | 11.61% | 0.17% |

⁸Assumes equal aluminum contents for the soluble and insoluble portions.
⁹Assumes all TMA present in the solid MAO was extracted into the solution. This assumption slightly over-estimates the TMA contents of the solution.
¹⁰Assumes all toluene present in the solid was extracted into the solution.

### EXAMPLES 62-73

Examples 62-70 illustrate the solubility of MAO in various hydrocarbon solvents when the MAO solutions were formed from slurries having differing MAO content.

In a nitrogen atmosphere at ambient temperatures, individual weighed portions of solid MAO from Example 1 were combined with various saturated hydrocarbons, in proportions such that slurries containing 5, 15 and 45 wt % MAO were formed. After thorough mixing, the solid MAO which did not dissolve was collected by centrifugation. The amount of MAO that dissolved was determined as described for Examples 3-20. Table IV sets forth the amounts of solid MAO that dissolved in each respective solvent mixture along with the mole% trimethylaluminum, wt % aluminum, and wt % toluene present in each of the respective solutions.

TABLE IV

| | | | Amount | | Calculated | | |
|---|---|---|---|---|---|---|---|
| | | | (wt %) of | Calculated | wt % | Calculated | Calculated |
| | | Slurry | Solid | wt % | Aluminum | Mole % | wt % |
| | | wt % | MAO | MAO in | in | TMA in | Toluene in |
| Example | Solvent | MAO | Dissolved | Solution | Solution¹¹ | Solution¹² | Solution¹³ |
| 62 | cyclopentane | 5 | 92% | 4.6% | 2.0% | 9.34% | 0.16% |
| 63 | cyclopentane | 15 | 92% | 14.0% | 6.0% | 9.34% | 0.16% |
| 64 | cyclopentane | 45 | 94% | 43.5% | 18.6% | 9.14% | 0.16% |
| 65 | methylcyclohexane | 5 | 82% | 4.1% | 1.8% | 10.48% | 0.16% |
| 66 | methylcyclohexane | 15 | 83% | 12.8% | 5.5% | 10.35% | 0.16% |
| 67 | methylcyclohexane | 45 | 90% | 42.4% | 18.2% | 9.54% | 0.16% |
| 68 | heptane | 5 | 73% | 3.7% | 1.6% | 11.77% | 0.17% |
| 69 | heptane | 16 | 57% | 9.8% | 4.2% | 15.07% | 0.18% |
| 70 | heptane | 46 | 56% | 32.3% | 13.8% | 15.34% | 0.18% |

¹¹Assumes equal aluminum contents for the soluble and insoluble portions.
¹²Assumes all TMA present in the solid MAO was extracted into the solution. This assumption slightly over-estimates the TMA contents of the solution.
¹³Assumes all toluene present in the solid was extracted into the solution.

Polymerization Reactions Using New Aluminoxanes of This Invention as Co-Catalysts

In conducting olefin polymerization reactions of this invention a wide variety of transition, actinide, or lanthanide metal-containing catalyst compounds can be used. Suitable catalyst compounds can also be described as d- and f-block metal compounds. See, for example, the Periodic Table appearing on page 225 of Moeller, et al., Chemistry, Second Edition, Academic Press, copyright 1984. As regards the metal constituent, preferred are compounds of Fe, Co, Ni, Pd, and V. More preferred are compounds of the metals of Groups 4-6 (Ti, Zr, Hf. V, Nb, Ta, Cr, Mo, and W), and most preferred are the Group 4 metals, especially titanium, or hafnium, and most especially zirconium.

Non-limiting examples of olefin polymerization catalysts with which the new methylaluminoxanes of this invention can be used in forming novel highly effective catalysts of this invention include metallocenes and/or transition metal compounds. As used in the specification and claims hereof, the term “metallocene” includes metal derivatives which contain at least one cyclopentadienyl moiety. Suitable metallocenes are well known in the art and include the metallocenes of Groups 3, 4, 5, 6, lanthanide and actinide metals, for example, the metallocenes which are described in U.S. Pat. Nos. 2,864,843; 2,983,740; 4,665,046; 4,874,880; 4,892,851; 4,931,417; 4,952,713; 5,017,714; 5,026,798; 5,036,034; 5,064,802; 5,081,231; 5,145,819; 5,162,278; 5,245,019; 5,268,495; 5,276,208; 5,304,523; 5,324,800; 5,329,031; 5,329,033; 5,330,948,5,347,025; 5,347,026; and 5,347,752, whose teachings with respect to such metallocenes are incorporated herein by reference.

Metallocene structures in this specification are to be interpreted broadly, and include structures containing 1, 2, 3 or 4 Cp or substituted Cp rings. Thus metallocenes suitable for use in this invention can be represented by Formula (I):

BₐCp_{b}MX_{c}Y_{d} (I)

where Cp, independently in each occurrence, is a cyclopentadienyl-moiety-containing group which typically has in the range of 5 to about 24 carbon atoms; B is a bridging group or ansa group that links two Cp groups together or alternatively carries an alternate coordinating group such as alkylaminosilylalkyl, silylamido, alkoxy, siloxy, aminosilylalkyl, or analogous monodentate hetero atom electron donating groups; M is a d- or f-block metal atom; each X and each Y is, independently, a group that is bonded to the d- or f-block metal atom; a is 0 or 1; b is a whole integer from 1 to 3 (preferably 2); c is at least 2; d is 0 or 1. The sum of b, c, and d is sufficient to form a stable compound, and often is the coordination number of the d- or f-block metal atom.

Cp is, independently, a cyclopentadienyl, indenyl, fluorenyl or related group that can π-bond to the metal, or a hydrocarbyl-, halo-, halohydrocarbyl-, hydrocarbylmetalloid-, and/or halohydrocarbylmetalloid-substituted derivative thereof. Cp typically contains up to 75 non-hydrogen atoms. B, if present, is typically a silylene (—SiR₂—), benzo (C₆H₄<), substituted benzo, methylene (—CH₂—), substituted methylene, ethylene (—CH₂CH₂—), or substituted ethylene bridge. M is preferably a metal atom of Groups 4-6, and most preferably is a Group 4 metal atom, especially hafnium, and most especially zirconium. X can be a divalent substituent such as an alkylidene group, a cyclometallated hydrocarbyl group, or any other divalent chelating ligand, two loci of which are singly bonded to M to form a cyclic moiety which includes M as a member. Each X, and if present Y, can be, independently in each occurrence, a halogen atom, a hydrocarbyl group (alkyl, cycloalkyl, alkenyl, cycloalkenyl, aryl, aralkyl, etc.), hydrocarbyloxy, (alkoxy, aryloxy, etc.) siloxy, amino or substituted amino, hydride, acyloxy, triflate, and similar univalent groups that form stable metallocenes. The sum of b, c, and d is a whole number, and is often from 3-5. When M is a Group 4 metal or an actinide metal, and b is 2, the sum of c and d is 2, c being at least 1. When M is a Group 3 or Lanthanide metal, and b is 2, c is 1 and d is zero. When M is a Group 5 metal, and b is 2, the sum of c and d is 3, c being at least 2.

Also useful in this invention are compounds analogous to those of Formula (I) where one or more of the Cp groups are replaced by cyclic unsaturated charged groups isoelectronic with Cp, such as borabenzene or substituted borabenzene, azaborole or substituted azaborole, and various other isoelectronic Cp analogs. See for example Krishnamurti, et al., U.S. Pat. No. 5,554,775 and 5,756,611.

In one preferred group of metallocenes, b is 2, i.e., there are two cyclopentadienyl-moiety containing groups in the molecule, and these two groups can be the same or they can be different from each other.

Another sub-group of useful metallocenes which can be used in the practice of this invention are metallocenes of the type described in WO 98/32776 published Jul. 30, 1998. These metallocenes are characterized in that one or more cyclopentadienyl groups in the metallocene are substituted by one or more polyatomic groups attached via a N, O, S, or P atom or by a carbon-to-carbon double bond. Examples of such substituents on the cyclopentadienyl ring include —OR, —SR, —NR₂, —CH═, —CR═, and —PR₂, where R can be the same or different and is a substituted or unsubstituted C₁-C₁₆ hydrocarbyl group, a tri-C₁-C₈ hydrocarbylsilyl group, a tri-C₁-C₈ hydrocarbyloxysilyl group, a mixed C₁-C₈ hydrocarbyl and C₁-C8 hydrocarbyloxysilyl group, a tri-C₁-C₈ hydrocarbylgermyl group, a tri-C₁-C₈ hydrocarbyloxygermyl group, or a mixed C₁-C8 hydrocarbyl and C₁-C₈ hydrocarbyloxygermyl group.

Examples of metallocenes to which this invention is applicable include such compounds as:

bis(cyclopentadienyl)zirconium dimethyl;

bis(cyclopentadienyl)zirconium dichloride;

bis(cyclopentadienyl)zirconium monomethylmonochloride;

bis(cyclopentadienyl)titanium dichloride;

bis(cyclopentadienyl)titanium difluoride;

cyclopentadienylzirconium tri-(2-ethylhexanoate);

bis(cyclopentadienyl)zirconium hydrogen chloride;

bis(cyclopentadienyl)hafnium dichloride;

racemic and meso dimethylsilanylene-bis(methylcyclopentadienyl)hafnium dichloride;

racemic dimethylsilanylene-bis(indenyl)hafnium dichloride;

racemic ethylene-bis(indenyl)zirconium dichloride;

(η⁵-indenyl)hafnium trichloride;

(η-C₅Me₅)hafnium trichloride;

racemic dimethylsilanylene-bis(indenyl)thorium dichloride;

racemic dimethylsilanylene-bis(4,7-dimethyl-1-indenyl)zirconium dichloride;

racemic dimethyl-silanylene-bis(indenyl)uranium dichloride;

racemic dimethylsilanylene-bis(2,3,5-trimethyl-1-cyclopentadienyl)zirconium dichloride;

racemic dimethyl-silanylene(3-methylcyclopentadienyl)hafnium dichloride;

racemic dimethylsilanylene-bis(1-(2-methyl-4-ethyl)indenyl) zirconium dichloride;

racemic dimethylsilanylene-bis(2-methyl-4,5,6,7-tetrahydro-1-indenyl) zirconium dichloride;

bis(pentamethylcyclopentadienyl)thorium dichloride;

bis(pentamethylcyclopentadienyl)uranium dichloride;

(tert-butylamido)dimethyl(tetramethyl-η⁵-cyclopentadienyl)silanetitanium dichloride;

(tert-butylamido)dimethyl(tetramethyl-η⁵-cyclopentadienyl)silane chromium dichloride;

(tert-butylamido)dimethyl(-η⁵-cyclopentadienyl)silanetitanium dichloride;

(tert-butylamido)dimethyl(tetramethyl-η⁵-cyclopentadienyl)silanemethyltitanium bromide;

(tert-butylamido)(tetramethyl-η⁵-cyclopentadienyl)-1,2-ethanediyluranium dichloride;

(tert-butylamido)(tetramethyl-η⁵-cyclopentadienyl)-1,2-ethanediyltitanium dichloride;

(methylamido)(tetramethyl-η⁵-cyclopentadienyl)-1,2-ethanediylcerium dichloride;

(methylamido)(tetramethyl-η⁵-cyclopentadienyl)-1,2-ethanediyltitanium dichloride;

(ethylamido)(tetramethyl-η⁵-cyclopentadienyl)methylenetitanium dichloride;

(tert-butylamido)dibenzyl(tetramethyl-η⁵-cyclopentadienyl)-silanebenzylvanadium chloride;

(benzylamido)dimethyl(indenyl)silanetitanium dichloride;

(phenylphosphido)dimethyl(tetramethyl-η⁵-cyclopentadienyl)silanebenzyltitanium chloride;

rac-dimethylsilylbis(2-methyl-1-indenyl)zirconium dimethyl;

rac-ethylenebis(1-indenyl)zirconium dimethyl;

bis(methylcyclopentadienyl)titanium dimethyl;

bis(methylcyclopentadienyl)zirconium dimethyl;

bis(n-butylcyclopentadienyl)zirconium dimethyl;

bis(dimethylcyclopentadienyl)zirconium dimethyl;

bis(diethylcyclopentadienyl)zirconium dimethyl;

bis(methyl-n-butylcyclopentadienyl)zirconium dimethyl;

bis(n-propylcyclopentadienyl)zirconium dimethyl;

bis(2-propylcyclopentadienyl)zirconium dimethyl;

bis(methylethylcyclopentadienyl)zirconium dimethyl;

bis(indenyl)zirconium dimethyl;

bis(methylindenyl)zirconium dimethyl;

dimethylsilylenebis(indenyl)zirconium dimethyl;

dimethylsilylenebis(2-methylindenyl)zirconium dimethyl;

dimethylsilylenebis(2-ethylindenyl)zirconium dimethyl;

dimethylsilylenebis(2-methyl-4-phenylindenyl)zirconium dimethyl;

1,2-ethylenebis(indenyl)zirconium dimethyl;

1,2-ethylenebis(methylindenyl)zirconium dimethyl;

2,2-propylidenebis(cyclopentadienyl)(fluorenyl)zirconium dimethyl;

dimethylsilylenebis(6-phenylindenyl)zirconium dimethyl;

bis(methylindenyl)zirconium benzyl methyl;

ethylenebis[2-(tert-butyldimethylsiloxy)-1-indenyl]zirconium dimethyl;

dimethylsilylenebis(indenyl)chlorozirconium methyl;

5-(cyclopentadienyl)-5-(9-fluorenyl)1-hexene zirconium dimethyl;

dimethylsilylenebis(2-methylindenyl)hafnium dimethyl;

dimethylsilylenebis(2-ethylindenyl)hafnium dimethyl;

dimethylsilylenebis(2-methyl-4-phenylindenyl)hafnium dimethyl;

2,2-propylidenebis(cyclopentadienyl)(fluorenyl)hafnium dimethyl;

bis(9-fluorenyl)(methyl)(vinyl)silane zirconium dimethyl,

bis(9-fluorenyl)(methyl)(prop-2-enyl)silane zirconium dimethyl,

bis(9-fluorenyl)(methyl)(but-3-enyl)silane zirconium dimethyl,

bis(9-fluorenyl)(methyl)(hex-5-enyl)silane zirconium dimethyl,

bis(9-fluorenyl)(methyl)(oct-7-enyl)silane zirconium dimethyl,

(cyclopentadienyl)(1-allylindenyl) zirconium dimethyl,

bis(1-allylindenyl)zirconium dimethyl,

(9-(prop-2-enyl)fluorenyl)(cyclopentadienyl)zirconium dimethyl,

(9-(prop-2-enyl)fluorenyl)(pentamethylcyclopentadienyl)zirconium dimethyl,

bis(9-(prop-2-enyl)fluorenyl) zirconium dimethyl,

(9-(cyclopent-2-enyl)fluorenyl)(cyclopentadienyl) zirconium dimethyl,

bis(9-(cyclopent-2-enyl)(fluorenyl)zirconium dimethyl,

5-(2-methylcyclopentadienyl)-5(9-fluorenyl)-1-hexene zirconium dimethyl,

1-(9-fluorenyl)-1-(cyclopentadienyl)-1-(but-3-enyl)-1-(methyl)methane zirconium dimethyl,

5-(fluorenyl)-5-(cyclopentadienyl)-1-hexene hafnium dimethyl,

(9-fluorenyl)(1-allylindenyl)dimethylsilane zirconium dimethyl,

1-(2,7-di(alpha-methylvinyl)(9-fluorenyl)-1-(cyclopentadienyl)-1,1-dimethylmethane zirconium dimethyl,

1-(2,7-di(cyclohex-1-enyl)(9-fluorenyl))-1-(cyclopentadienyl)-1,1-methane zirconium dimethyl

5-(cyclopentadienyl)-5-(9-fluorenyl)-1-hexene titanium dimethyl,

5-(cyclopentadienyl)-5-(9-fluorenyl)1-hexene titanium dimethyl,

bis(9-fluorenyl)(methyl)(vinyl)silane titanium dimethyl,

bis(9-fluorenyl)(methyl)(prop-2-enyl)silane titanium dimethyl,

bis(9-fluorenyl)(methyl)(but-3-enyl)silane titanium dimethyl,

bis(9-fluorenyl)(methyl)(hex-5-enyl)silane titanium dimethyl,

bis(9-fluorenyl)(methyl)(oct-7-enyl)silane titanium dimethyl,

(cyclopentadienyl)(1-allylindenyl) titanium dimethyl,

bis(1-allylindenyl)titanium dimethyl,

(9-(prop-2-enyl)fluorenyl)(cyclopentadienyl)hafnium dimethyl,

(9-(prop-2-enyl)fluorenyl)(pentamethylcyclopentadienyl)hafnium dimethyl,

bis(9-(prop-2-enyl)fluorenyl)hafnium dimethyl,

(9-(cyclopent-2-enyl)fluorenyl)(cyclopentadienyl)hafnium dimethyl,

bis(9-(cyclopent-2-enyl)(fluorenyl)hafnium dimethyl,

5-(2-methylcyclopentadienyl)-5(9-fluorenyl)-1-hexene hafnium dimethyl,

5-(fluorenyl)-5-(cyclopentadienyl)-1-octene hafnium dimethyl,

(9-fluorenyl)(1-allylindenyl)dimethylsilane hafnium dimethyl.

(tert-butylamido)dimethyl(tetramethylcyclopentadienyl)silane titanium(1,3-pentadiene);

(cyclopentadienyl)(9-fluorenyl)diphenylmethane zirconium dimethyl;

(cyclopentadienyl)(9-fluorenyl)diphenylmethane hafnium dimethyl;

dimethylsilanylene-bis(indenyl)thorium dimethyl;

dimethylsilanylene-bis(4,7-dimethyl-1-indenyl) zirconium dimethyl;

dimethylsilanylene-bis(indenyl) uranium dimethyl;

dimethylsilanylene-bis(2-methyl-4-ethyl-1-indenyl) zirconium dimethyl;

dimethylsilanylene-bis(2-methyl-4,5,6,7-tetrahydro-1-indenyl)zirconium dimethyl;

(tert-butylamido)dimethyl(tetramethyl-η⁵-cyclopentadienyl)silane titanium dimethyl;

(tert-butylamido)dimethyl(tetramethyl-η⁵-cyclopentadienyl)silane chromium dimethyl;

(tert-butylamido)dimethyl(tetramethyl-η⁵-cyclopentadienyl)silane titanium dimethyl;

(phenylphosphido)dimethyl(tetramethyl-η⁵-cyclopentadienyl)silane titanium dimethyl; and

[dimethylsilanediylbis(indenyl)]scandium methyl.

In many cases the metallocenes such as referred to above will exist as racemic mixtures, but pure enantiomeric forms or mixtures enriched in a given enantiomeric form can be used.

It is also possible to use compounds analogous to metallocenes where one or more of the cyclopentadienyl-moiety-containing (“Cp”) groups are replaced by cyclic unsaturated charged groups isoelectronic with Cp, such as borabenzene or substituted borabenzene, azaborole or substituted azaborole, and various other isoelectronic Cp analogs. See for example Krishnamurti, et al., U.S. Pat. Nos. 5,554,775 and 5,756,611.

Other organometallic catalytic compounds with which the modified methylaluminoxanes of this invention can be used in forming novel catalysts of this invention are the late transition metal catalyst described, for example, in U.S. Pat. No. 5,516,739 to Barborak, et al.; U.S. Pat. No. 5,561,216 to Barborak, et al.; and U.S. Pat. No. 5,880,241 to Brookhart, et al. Such catalysts are referred to herein, including the claims, collectively as “a Barborak-Brookhart late transition metal catalyst compound or complex”.

Suitable transition metal compounds also include the well known Ziegler-Natta catalyst compounds of Group 4-6 metals. Non-limiting illustrative examples of such transition metal compounds include TiCl₄, TiBr₄, Ti(OC₂H₅)₃Cl, Ti(OC₂H₅)Cl₃, Ti(OC₄H₉)₃Cl, Ti(OC₃H₇)₂Cl₂, Ti(OC₁₇)₂Br₂, VCl₄, VOCl₃, VO(OC₂H₅)₃, ZrCl₄, ZrCl₃(OC₂H₅), Zr(OC₂H₅)₄, ZrCl(OC₄H₉)₃, and the like.

Illustrative, non-limiting additional examples of various types of transition metal compounds that can be employed include the following:

2,6-bis-[1-(1-methylphenylimino)ethyl]pyridine iron[II] chloride;

2,6-bis[1-(1-ethylphenylimino)ethyl]pyridine iron[II] chloride;

2,6-bis[1-(1-isopropylphenylimino)ethyl]pyridine iron[II] chloride;

2,6-bis-(1-(2-methylphenylimino)ethyl)pyridine iron(II) chloride;

N,N′-di(trimethylsilyl)benzamidinato copper(II);

tridentate Schiff base complexes of cobalt and iron described by Mashima in Shokubai 1999, vol. 41, p. 58;

nickel compounds of the type described in U.S. Pat. No. 5,880,323;

nickel(II) acetylacetonate;

bis(acetonitrile)dichloropalladium(II);

bis(acetonitrile)bis(tetrafluoroborate)palladium(II);

(2,2′-bipyridine)dichloropalladium(II);

bis(cyclooctadienyl) nickel(0);

palladium(II) acetylacetonate;

bis(salicylaldiminato) complexes of the type described by Matsui et. al. in Chemistry Letters 2000, pp. 554-555;

cobalt dioctoate;

cobaltocene;

(cyclopentadienyl)(triphenylphosphino)cobalt(II) diiodide; and

nickel compounds of the type described in JP 09-272709.

Indeed, it is entirely reasonable to expect that the methylaluminoxanes of this invention can be used with any metal-containing catalyst with which methylaluminoxane can be used, and thus such use is deemed within the scope of the present invention.

The catalyst compositions of this invention are formed from at least (i) a transition, lanthanide, or actinide metal catalyst component such as referred to above, e.g., a metallocene, a Ziegler-Natta Group 4-6 metal catalyst compound, or a late transition metal catalyst of the type described in U.S. Pat. No. 5,516,739 to Barborak, et al.; U.S. Pat. No. 5,561,216 to Barborak, et al.; and U.S. Pat. No. 5,880,241 to Brookhart, et al, i.e., a Barborak-Brookhart late transition metal catalyst compound or complex, and (ii) a methylaluminoxane composition of this invention. Other components such as aluminum alkyls, boranes, and other types of aluminoxanes, can be used in conjunction with these catalyst compositions. The catalyst components will typically be used in proportions to provide mole ratios of transition, lanthanide, or actinide metal atom to aluminum atom of in the range of about 0.0002:1 to about 0.2:1 and preferably in the range of about 0.0005:1 to about 0.02:1. In conducting polymerizations pursuant to this invention, higher or lower ratios can be used in any situation where deemed necessary or desirable.

In conducting the polymerizations pursuant to this invention, the catalyst components can be used in solution or deposited on a solid support. When used in solution polymerization, the solvent can be, where applicable, a large excess quantity of the liquid olefinic monomer. Typically, however, an ancillary inert solvent, typically a liquid paraffinic or aromatic hydrocarbon solvent is used, such as heptane, isooctane, decane, toluene, xylene, ethylbenzene, mesitylene, or mixtures of liquid paraffinic hydrocarbons and/or liquid aromatic hydrocarbons.

Polymers can be produced pursuant to this invention by homopolymerization of olefins, typically 1-olefins (also known as α-olefins) such as ethylene, propylene, 1-butene, styrene, or copolymerization of two or more copolymerizable monomers, at least one of which is typically a 1-olefin. The other monomer(s) used in forming such copolymers can be one or more different 1-olefins and/or a diolefin, and/or a acetylenic monomer. Olefins that can be polymerized in the presence of the catalyst compositions of this invention include α-olefins having 2 to 20 carbon atoms such as ethylene, propylene, 1-butene, 1-hexene, 4-methyl-1-pentene, 1-octene, 1-decene, 1-dodecene, 1-tetradecene, 1-hexadecene, and 1-octadecene. Normally, the hydrocarbon monomers used, such as 1-olefins, diolefins and/or acetylene monomers, will contain up to about 10 carbon atoms per molecule. Preferred 1-olefin monomers for use in the process include ethylene, propylene, 1-butene, 3-methyl-1-butene, 4-methyl-1-pentene, 1-hexene, and 1-octene. It is particularly preferred to use supported or unsupported catalysts of this invention in the polymerization of ethylene, or propylene, or ethylene and at least one C₃-C₈ 1-olefin copolymerizable with ethylene. Typical diolefin monomers which can be used to form terpolymers with ethylene and propylene include butadiene, hexadiene, norbornadiene, and similar copolymerizable diene hydrocarbons. 1-Heptyne and 1-octyne are illustrative of suitable acetylenic monomers which can be used.

Often the monomer used is a 1-alkene monomer whereby a homopolymer is prepared. In other frequent cases a mixture of a 1-alkene monomer such as ethylene and at least one monomer copolymerizable therewith is used whereby a copolymer is produced.

Polymerization of ethylene or copolymerization with ethylene and an α-olefin having 3 to 10 carbon atoms may be performed in either the gas or liquid phase (e.g., in a solvent, such as toluene, or heptane). The polymerization can be conducted at conventional temperatures (e.g., 0° to 120° C.) and pressures (e.g., ambient to 50 kg/cm²) using conventional procedures as to molecular weight regulations and the like.

The heterogeneous catalysts of this invention can be used in polymerizations conducted as slurry processes or as gas phase processes. By “slurry” in this connection is meant that the particulate catalyst is used as a slurry or dispersion in a suitable liquid reaction medium which may be composed of one or more ancillary solvents (e.g., liquid aliphatic or aromatic hydrocarbons, etc.) or an excess amount of liquid monomer to be polymerized in bulk. Generally speaking, these polymerizations are conducted at one or more temperatures in the range of about 0 to about 160° C. and under atmospheric, subatmospheric, or superatmospheric conditions. Preferably polymerizations conducted in a liquid reaction medium containing a slurry or dispersion of a catalyst of this invention are conducted at temperatures in the range of about 40 to about 110° C. Typical liquid diluents for such processes include isobutane, pentane, isopentane, hexane, heptane, toluene, and like materials. Typically, when conducting gas phase polymerizations, superatmospheric pressures are used, and the reactions are conducted at temperatures in the range of about 50 to about 160° C. These gas phase polymerizations can be performed in a stirred or fluidized bed of catalyst in a pressure vessel adapted to permit the separation of product particles from unreacted gases. Thermostated ethylene, comonomer, hydrogen and an inert diluent gas such as nitrogen can be introduced or recirculated to maintain the particles at the desired polymerization reaction temperature. An aluminum alkyl such as triethylaluminum may be added as a scavenger of water, oxygen and other impurities. In such cases the aluminum alkyl is preferably employed as a solution in a suitable dry liquid hydrocarbon solvent such as toluene or xylene. Concentrations of such solutions in the range of about 5×10⁻⁵ molar are conveniently used. But solutions of greater or lesser concentrations can be used, if desired. Polymer product can be withdrawn continuously or semi-continuously at a rate that maintains a constant product inventory in the reactor.

The catalyst compositions of this invention can also be used along with hydrocarbylborane compounds such as triethylborane, tripropylborane, tributylborane, tri-sec-butylborane. When so used, molar Al/B ratios in the range of about 1/1 to about 1/50 or more can be used.

In general, the polymerizations and copolymerizations conducted pursuant to this invention are carried out using a catalytically effective amount of a novel catalyst composition of this invention, which amount may be varied depending upon such factors such as the type of polymerization being conducted, the polymerization conditions being used, and the type of reaction equipment in which the polymerization is being conducted. In many cases, the amount of the catalyst of this invention used will be such as to provide in the range of about 0.000001 to about 0.01 percent by weight of transition, lanthanide, or actinide metal based on the weight of the monomer(s) being polymerized.

After polymerization and deactivation of the catalyst in a conventional manner, the product polymer can be recovered from the polymerization reactor by any suitable means. When conducting the process with a slurry or dispersion of the catalyst in a liquid medium the product typically is recovered by a physical separation technique (e.g., decantation, etc.). The recovered polymer is usually washed with one or more suitably volatile solvents to remove residual polymerization solvent or other impurities, and then dried, typically under reduced pressure with or without addition of heat. When conducting the process as a gas phase polymerization, the product after removal from the gas phase reactor is typically freed of residual monomer by means of a nitrogen purge, and may possibly be used without further catalyst deactivation or catalyst removal.

When preparing polymers pursuant to this invention conditions may be used for preparing unimodal or multimodal polymer types. For example, mixtures of catalysts of this invention formed from two or more different metallocenes having different propagation and termination rate constants for ethylene polymerizations can be used in preparing polymers having broad molecular weight distributions of the multimodal type.

The solid support used in forming the supported catalysts of this invention and also the supported methylaluminoxane compositions of this invention can be any particulate solid, and particularly porous supports. Non-limiting examples include talc, magnesium halides, zeolites, inorganic oxides, and resinous support material such as polyolefins. A preferred support material is an inorganic oxide in finely divided form. Such inorganic oxide support materials include Group 2, 4, 13, or 14 metal oxides such as silica, alumina, silica-alumina and mixtures thereof. Other inorganic oxides that may be employed either alone or in combination with the silica, alumina or silica-alumina are magnesia, titania, zirconia, and the like. Other suitable support materials are finely divided polyolefins such as finely divided polyethylene.

The specific particle size, surface area, pore diameter, pore volume, etc. of the support materials are selected as known in the art. For example, particle sizes of from about 0.1 to 600 micrometers, surface area of from about 50 to 1000 m²/g, pore diameters of from about 50-500 angstroms and pore volumes of from about 0.3 to 5.0 cc/g. The supports can be dehydrated either chemically or by heating at temperatures of from about 100° C. to 1000° C. in a dry inert gas for 1-24 hours as is known in the art.

Suitable inorganic oxide support materials which are desirably employed include metal oxides such as silica, alumina, silica-alumina and mixtures thereof. Other inorganic oxides that may be employed either alone or in combination with the silica, alumina or silica-alumina are magnesia, titania, zirconia, and like metal oxides. Other suitable support materials are finely divided polyolefins such as finely divided polyethylene.

Methods of depositing catalyst components on supports or carriers are known and reported in the literature, and can readily be adapted for use in forming the supported catalysts of this invention. Thus use may be made of the methods described, for example, in U.S. Pat. No. 5,332,706 to Nowlin et al., but of course using a modified aluminoxane of this invention in the procedure.

In the embodiments of this invention wherein an aluminoxane of this invention is supported on a catalyst support material, the solid support or carrier can be any suitable particulate solid, and particularly a porous support such as those referred to above. The amount of modified aluminoxane on the support or carrier is not critical as long as there is a sufficient amount to serve as a cocatalyst with the transition, lanthanide, or actinide metal catalyst component such as a metallocene or Ziegler-Natta Group 4-6 metal catalyst compound to be used therewith or subsequently deposited thereon. Any suitable method can be used for depositing the modified methylaluminoxane on the support or carrier. Typically the dried or calcined particulate support will be contacted with a solution of the modified methylaluminoxane. Thereafter the solvent is evaporated from the impregnated particles under suitable conditions of temperature and pressure. These operations are, of course, also conducted under suitably anhydrous conditions. As an example of a procedure which can be used for supporting the modified methylaluminoxanes of this invention on a support, see for example, U.S. Pat. No. 5,856,255 to Krzystowczyk et al.

Reaction Conditions

To produce the catalytically active catalyst compositions of this invention the reactants, the d- or f-block metal compound, and the hydroxyaluminoxane that has either been freshly prepared or stored at low temperature (e.g., −10° C. or below) are brought together preferably in solution form or on a support. The reaction between the hydroxy group and the bond between the leaving group and the d- or f-block metal is stoichiometric and thus the proportions used should be approximately equimolar. The temperature of the reaction mixture is kept in the range of about −78 to about 160° C. and preferably in the range of about 15 to about 30° C. The reaction is conducted under an inert atmosphere and in an inert environment such as in an anhydrous solvent medium. Reaction times are short, typically within four hours. When the catalyst composition is to be in supported form on a catalyst support or carrier, the suitably dried, essentially hydrate-free support can be included in the reaction mixture. However, it is possible to add the catalyst to the support after the catalyst composition has been formed.

Polymerization Processes Using Catalysts of this Invention

The catalyst compositions of this invention can be used in solution or deposited on a solid support. When used in solution polymerization, the solvent can be, where applicable, a large excess quantity of the liquid olefinic monomer. Typically, however, an ancillary inert solvent, typically a liquid paraffinic or aromatic hydrocarbon solvent is used, such as heptane, isooctane, decane, toluene, xylene, ethylbenzene, mesitylene, or mixtures of liquid paraffinic hydrocarbons and/or liquid aromatic hydrocarbons. When the catalyst compositions of this invention are supported on a carrier, the solid support or carrier can be any suitable particulate solid, and particularly a porous support such as talc, zeolites, or inorganic oxides, or resinous support material such as polyolefins. Preferably, the support material is an inorganic oxide in finely divided form.

Suitable inorganic oxide support materials which are desirably employed include metal oxides such as silica, alumina, silica-alumina and mixtures thereof. Other inorganic oxides that may be employed either alone or in combination with the silica, alumina or silica-alumina are magnesia, titania, zirconia, and like metal oxides. Other suitable support materials are finely divided polyolefins such as finely divided polyethylene.

Polymers can be produced pursuant to this invention by homopolymerization of polymerizable olefins, typically 1-olefins (also known as α-olefins) such as ethylene, propylene, 1-butene, styrene, or copolymerization of two or more copolymerizable monomers, at least one of which is typically a 1-olefin. The other monomer(s) used in forming such copolymers can be one or more different 1-olefins and/or a diolefin, and/or a polymerizable acetylenic monomer. Olefins that can be polymerized in the presence of the catalysts of this invention include α-olefins having 2 to 20 carbon atoms such as ethylene, propylene, 1-butene, 1-hexene, 4-methyl-1-pentene, 1-octene, 1-decene, 1-dodecene, 1-tetradecene, 1-hexadecene, and 1-octadecene. Normally, the hydrocarbon monomers used, such as 1-olefins, diolefins and/or acetylene monomers, will contain up to about 10 carbon atoms per molecule. Preferred 1-olefin monomers for use in the process include ethylene, propylene, 1-butene, 3-methyl-1-butene, 4-methyl-1-pentene, 1-hexene, and 1-octene. It is particularly preferred to use supported or unsupported catalysts of this invention in the polymerization of ethylene, or propylene, or ethylene and at least one C₃-C₈ 1-olefin copolymerizable with ethylene. Typical diolefin monomers which can be used to form terpolymers with ethylene and propylene include butadiene, hexadiene, norbornadiene, and similar copolymerizable diene hydrocarbons. 1-Heptyne and 1-octyne are illustrative of suitable acetylenic monomers which can be used.

Polymerization of ethylene or copolymerization with ethylene and an α-olefin having 3 to 10 carbon atoms may be performed in either the gas or liquid phase (e.g. in a solvent, such as toluene, or heptane). The polymerization can be conducted at conventional temperatures (e.g., 0° to 120° C.) and pressures (e.g., ambient to 50 kg/cm²) using conventional procedures as to molecular weight regulations and the like.

The heterogeneous catalysts of this invention can be used in polymerizations conducted as slurry processes or as gas phase processes. By “slurry” is meant that the particulate catalyst is used as a slurry or dispersion in a suitable liquid reaction medium which may be composed of one or more ancillary solvents (e.g., liquid aromatic hydrocarbons, etc.) or an excess amount of liquid monomer to be polymerized in bulk. Generally speaking, these polymerizations are conducted at one or more temperatures in the range of about 0 to about 160° C., and under atmospheric, subatmospheric, or superatmospheric conditions. Conventional polymerization adjuvants, such as hydrogen, may be employed if desired. Preferably polymerizations conducted in a liquid reaction medium containing a slurry or dispersion of a catalyst of this invention are conducted at temperatures in the range of about 40 to about 110° C. Typical liquid diluents for such processes include hexane, toluene, and like materials. Typically, when conducting gas phase polymerizations, superatmospheric pressures are used, and the reactions are conducted at temperatures in the range of about 50 to about 160° C. These gas phase polymerizations can be performed in a stirred or fluidized bed of catalyst in a pressure vessel adapted to permit the separation of product particles from unreacted gases. Thermostated ethylene, comonomer, hydrogen and an inert diluent gas such as nitrogen can be introduced or recirculated to maintain the particles at the desired polymerization reaction temperature. An aluminum alkyl such as triethylaluminum may be added as a scavenger of water, oxygen and other impurities. In such cases the aluminum alkyl is preferably employed as a solution in a suitable dry liquid hydrocarbon solvent such as toluene or xylene. Concentrations of such solutions in the range of about 5×10⁻⁵ molar are conveniently used. But solutions of greater or lesser concentrations can be used, if desired. Polymer product can be withdrawn continuously or semi-continuously at a rate that maintains a constant product inventory in the reactor.

The catalyst compositions of this invention can also be used along with small amounts of hydrocarbylborane compounds such as triethylborane, tripropylborane, tributylborane, tri-sec-butylborane. When so used, molar Al/B ratios in the range of about 1/1 to about 1/500 can be used.

Because of the high activity and productivity of the catalysts of this invention, the catalyst levels used in olefin polymerizations can be less than previously used in typical olefin polymerizations conducted on an equivalent scale. In general, the polymerizations and copolymerizations conducted pursuant to this invention are carried out using a catalytically effective amount of a novel catalyst composition of this invention, which amount may be varied depending upon such factors such as the type of polymerization being conducted, the polymerization conditions being used, and the type of reaction equipment in which the polymerization is being conducted. In many cases, the amount of the catalyst of this invention used will be such as to provide in the range of about 0.000001 to about 0.01 percent by weight of d- or f-block metal based on the weight of the monomer(s) being polymerized.

The catalyst compositions used in the practice of this invention can be preformed catalyst compositions or they can be in situ formed catalyst compositions. Also, catalyst compositions composed of both preformed and in situ formed catalyst compositions can be used. By “preformed” is meant that the catalyst composition is produced outside of the polymerization reactor or polymerization zone in which the polymerization using such catalyst is to take place. Typically this involves bringing catalyst and co-catalyst components together in suitable relative proportions and under appropriate inert and anhydrous conditions in a suitable vessel. By “in situ formed” is meant that the catalyst is formed in place—i.e., the catalyst is formed in the polymerization reactor or polymerization zone in which the polymerization using such catalyst is to take place and/or is taking place. Typically this involves feeding catalyst and co-catalyst components in suitable relative proportions and under appropriate anhydrous conditions into the polymerization reactor or polymerization zone in which the polymerization using such catalyst is to take place and/or is taking place, so that the components come into contact therein and form the active catalyst composition. A feature of the methylaluminoxane compositions of this invention is that they can be fed into the polymerization reactor or polymerization zone either as particulate solids or as a solution or slurry in a suitable solvent, preferably a non-aromatic hydrocarbon solvent such as an aliphatic hydrocarbon solvent such as pentane, hexane, or heptane, or in a cycloaliphatic hydrocarbon solvent such as cyclopentane, cyclohexane, or methylcyclopentane.

After polymerization and deactivation of the catalyst in a conventional manner, the product polymer can be recovered from the polymerization reactor by any suitable means. When conducting the process with a slurry or dispersion of the catalyst in a liquid medium the product typically is recovered by a physical separation technique (e.g. decantation, etc.). The recovered polymer is usually washed with one or more suitably volatile solvents to remove residual polymerization solvent or other impurities, and then dried, typically under reduced pressure with or without addition of heat. When conducting the process as a gas phase polymerization, the product after removal from the gas phase reactor is typically freed of residual monomer by means of a nitrogen purge, and often can be used without further catalyst deactivation or catalyst removal.

When preparing polymers pursuant to this invention conditions may be used for preparing unimodal or multimodal polymer types. For example, mixtures of catalysts of this invention formed from two or more different metallocenes having different propagation and termination rate constants for ethylene polymerizations can be used in preparing polymers having broad molecular weight distributions of the multimodal type.

It is to be understood that the reactants and components referred to by chemical name or formula anywhere in the specification or claims hereof, whether referred to in the singular or plural, are identified as they exist prior to coming into contact with another substance referred to by chemical name or chemical type (e.g., another reactant, a solvent, or etc.). It matters not what preliminary chemical changes, transformations and/or reactions, if any, take place in the resulting mixture or solution or reaction medium as such changes, transformations and/or reactions are the natural result of bringing the specified reactants and/or components together under the conditions called for pursuant to this disclosure. Thus the reactants and components are identified as ingredients to be brought together in connection with performing a desired chemical reaction or in forming a mixture to be used in conducting a desired reaction. Accordingly, even though the claims hereinafter may refer to substances, components and/or ingredients in the present tense (“comprises”, “is”, etc.), the reference is to the substance, component or ingredient as it existed at the time just before it was first contacted, blended or mixed with one or more other substances, components and/or ingredients in accordance with the present disclosure. Whatever transformations, if any, that occur in situ as a reaction is conducted is what the claim is intended to cover. Thus the fact that a substance, component or ingredient may have lost its original identity through a chemical reaction or transformation during the course of contacting, blending or mixing operations, if conducted in accordance with this disclosure and with the application of common sense and the ordinary skill of a chemist, is thus wholly immaterial for an accurate understanding and appreciation of the true meaning and substance of this disclosure and the claims thereof.

Each and every patent or other publication referred to in any portion of this specification is incorporated in toto into this disclosure by reference, as if fully set forth herein.

This invention is susceptible to considerable variation in its practice. Therefore the foregoing description is not intended to limit, and should not be construed as limiting, the invention to the particular exemplifications presented hereinabove. Rather, what is intended to be covered is as set forth in the ensuing claims and the equivalents thereof permitted as a matter of law.

That which is claimed is:

1. A polymerization process which comprises contacting at least one polymerizable olefin monomer under polymerization conditions with a catalyst composition formed from components comprising (i) at least one d- or f-block metal-containing olefin polymerization catalyst compound or complex, and (ii) a methylaluminoxane composition, wherein said methylaluminoxane composition which, when by itself in the form of solid particles or powder, meets each of the following requirements:
A) said methylaluminoxane composition does not melt or otherwise exist as a liquid when at 25° C.;
B) said methylaluminoxane composition has a total aluminum content in the range of about 39 to about 47 wt % based on the total weight of the methylaluminoxane composition in the particulate or powder form;
C) said methylaluminoxane composition is either free of aluminum in the form of trimethylaluminum or if trimethylaluminum is present in the methylaluminoxane composition, not more than about 30 mole % of the total aluminum present in the methylaluminoxane composition is in the form of trimethylaluminum;
D) said methylaluminoxane composition contains no more than about 7500 ppm (wt/wt) of aromatic hydrocarbon;
E) said methylaluminoxane composition has a cryoscopic number average molecular weight as determined in benzene of at least about 1000 atomic mass units; and
F) said methylaluminoxane composition has sufficient solubility in n-heptane at 25° C. to provide a solution containing at least 4 wt % of dissolved aluminum.

2. A process according to claim 1 wherein said at least one polymerizable olefin monomer is at least one C₂-C₈ alpha-olefin.

3. A process according to claim 1 wherein said at least one polymerizable olefin monomer is ethylene.

4. A process according to claim 1 wherein said at least one polymerizable olefin monomer is propylene.

5. A process according to claim 1 wherein said at least one polymerizable olefin monomer is a combination of at least two said monomers that are copolymerizable with each other.

6. A process according to claim 5 wherein one of said monomers is ethylene.

7. A process according to claim 5 wherein said combination is a combination of ethylene and at least one alpha-olefin that is copolymerizable with ethylene and that has in the range of about 5 to about 8 carbon atoms in the molecule.

8. A process according to claim 1 wherein said catalyst composition is a preformed catalyst composition.

9. A process according to claim 1 wherein said catalyst composition is an in situ formed catalyst composition.

10. A process according to any of claims 1, 8, or 9 wherein said catalyst composition is supported on a catalyst support or carrier.

11. A process according to claim 10 wherein said catalyst support or carrier is an inorganic catalyst support or carrier.

12. A process according to any of claims 1, 2, 3, 4, 5, 6, 7, 8, or 9 wherein said at least one d- or f-block metal-containing olefin polymerization catalyst compound or complex used in forming said catalyst composition is at least one metallocene.

13. A process according to claim 12 wherein said at least one metallocene is at least one metallocene in which the metal is a Group 4 metal.

14. A polymerization process in which at least one polymerizable olefin monomer is polymerized in a polymerization reactor or reaction zone and in the presence of a metal-containing polymerization catalyst, wherein said metal-containing polymerization catalyst is formed from at least one d- or f-block metal-containing olefin polymerization catalyst compound or complex, and wherein before and/or during the polymerization there is fed into said polymerization reactor or reaction zone, at least one co-catalyst component which comprises a methylaluminoxane composition, which methylaluminoxane composition meets each of the following requirements:
A) said methylaluminoxane composition does not melt or otherwise exist as a liquid when at 25° C.;
B) said methylaluminoxane composition has a total aluminum content in the range of about 39 to about 47 wt % based on the total weight of the methylaluminoxane composition in the particulate or powder form;
C) said methylaluminoxane composition is either free of aluminum in the form of trimethylaluminum or if trimethylaluminum is present in the methylaluminoxane composition, not more than about 30 mole % of the total aluminum present in the methylaluminoxane composition is in the form of trimethylaluminum;
D) said methylaluminoxane composition contains no more than about 7500 ppm (wt/wt) of aromatic hydrocarbon;
E) said methylaluminoxane composition has a cryoscopic number average molecular weight as determined in benzene of at least about 1000 atomic mass units; and
F) said methylaluminoxane composition has sufficient solubility in n-heptane at 25° C. to provide a solution containing at least 4 wt % of dissolved aluminum.

15. A process according to claim 14 wherein said at least one polymerizable olefin monomer is at least one C₂-C₈ alpha-olefin.

16. A process according to claim 14 wherein said at least one polymerizable olefin monomer is ethylene.

17. A process according to claim 14 wherein said at least one polymerizable olefin monomer is propylene.

18. A process according to claim 14 wherein said at least one polymerizable olefin monomer is a combination of at least two said monomers that are copolymerizable with each other.

19. A process according to claim 18 wherein one of said monomers is ethylene.

20. A process according to claim 18 wherein said combination is a combination of ethylene and at least one alpha-olefin that is copolymerizable with ethylene and that has in the range of about 5 to about 8 carbon atoms in the molecule.

21. A process according to claim 14 wherein said catalyst is supported on a catalyst support or carrier.

22. A process according to claim 21 wherein said catalyst support or carrier is an inorganic catalyst support or carrier.

23. A process according to any of claims 14, 15, 16, 17, 18, 19, 20, 21, or 22 wherein said olefin polymerization catalyst compound or complex is at least one metallocene.

24. A process according to claim 23 wherein said at least one metallocene is at least one metallocene in which the metal is a Group 4 metal.

25. A process according to claim 14 wherein said at least one co-catalyst component consists essentially of said methylaluminoxane composition and wherein said methylaluminoxane composition is fed into said polymerization reactor or reaction zone in the form of particulate or powdery solids.

26. A process according to claim 14 wherein said at least one co-catalyst component is fed into said polymerization reactor or reaction zone in the form of a slurry in a liquid hydrocarbon.

27. A process according to claim 14 wherein said at least one co-catalyst component is fed into said polymerization reactor or reaction zone in the form of a solution in a liquid hydrocarbon.

28. A process according to claims 26 or 27 wherein said liquid hydrocarbon is at least one liquid non-aromatic hydrocarbon.

29. A process according to claim 28 wherein said at least one liquid non-aromatic hydrocarbon is (i) at least one saturated aliphatic hydrocarbon or (ii) at least one saturated cycloaliphatic hydrocarbon, or (iii) a combination of (i) and (ii) hereof.

30. A process according to claim 28 wherein said at least one liquid non-aromatic hydrocarbon is (i) at least one polymerizable olefinic monomer, (ii) a combination of at least one polymerizable olefinic monomer and at least one saturated aliphatic hydrocarbon, (iii) a combination of at least one polymerizable olefinic monomer and at least one saturated cycloaliphatic hydrocarbon, or (iv) a mixture of any two or all three of (i), (ii), and (iii) hereof.

31. A process according to claim 14 wherein said olefin polymerization compound or complex and said at least one co-catalyst component are concurrently cofed into said reactor or reaction zone as separate feeds.

32. A process according to claim 31 wherein said at least one co-catalyst component consists essentially of said methylaluminoxane composition and wherein said separate feed of said methylaluminoxane composition is fed into said polymerization reactor or reaction zone in the form of particulate or powdery solids.

33. A process according to claim 31 wherein said at least one co-catalyst component consists essentially of said methylaluminoxane composition and wherein said separate feed of said methylaluminoxane composition is fed into said polymerization reactor or reaction zone in the form of a solution or slurry in a liquid hydrocarbon.

34. A process according to claim 33 wherein said liquid hydrocarbon is at least one liquid non-aromatic hydrocarbon.

35. A process according to claim 33 wherein said liquid hydrocarbon is (i) at least one saturated aliphatic hydrocarbon or (ii) at least one saturated cycloaliphatic hydrocarbon, or (iii) a combination of (i) and (ii) hereof.

36. A process according to claim 33 wherein said liquid hydrocarbon is (i) at least one polymerizable olefinic monomer, (ii) a combination of at least one polymerizable olefinic monomer and at least one saturated aliphatic hydrocarbon, (iii) a combination of at least one polymerizable olefinic monomer and at least one saturated cycloaliphatic hydrocarbon, or (iv) a mixture of any two or all three of (i), (ii), and (iii) hereof.

37. A polymerization process which comprises contacting at least one polymerizable olefin monomer under polymerization conditions with a heterogeneous catalyst composition formed from components which comprise (i) at least one d- or f-block metal-containing olefin polymerization catalyst compound or complex, and (ii) a methylaluminoxane composition which meets each of the following requirements:
A) said methylaluminoxane composition does not melt or otherwise exist as a liquid when at 25° C.;
B) said methylaluminoxane composition has a total aluminum content in the range of about 39 to about 47 wt % based on the total weight of the methylaluminoxane composition in the particulate or powder form;
C) said methylaluminoxane composition is either free of aluminum in the form of trimethylaluminum or if trimethylaluminum is present in the methylaluminoxane composition, not more than about 30 mole % of the total aluminum present in the methylaluminoxane composition is in the form of trimethylaluminum;
D) said methylaluminoxane composition contains no more than about 7500 ppm (wt/wt) of aromatic hydrocarbon;
E) said methylaluminoxane composition has a cryoscopic number average molecular weight as determined in benzene of at least about 1000 atomic mass units; and
F) said methylaluminoxane composition has sufficient solubility in n-heptane at 25° C. to provide a solution containing at least 4 wt % of dissolved aluminum.
and wherein said heterogeneous catalyst composition (1) is prepolymerized with alpha-olefin monomer or (2) is supported on a catalyst support or carrier, or (3) is supported on a catalyst support or carrier and also prepolymerized with alpha-olefin monomer.

38. A process according to claim 37 wherein said at least one d- or f-block metal-containing olefin polymerization catalyst compound or complex is at least one metallocene.

39. A process according to claim 38 wherein said at least one metallocene is at least one metallocene in which the metal is a Group 4 metal.

40. A process according to claim 37 wherein said at least one polymerizable olefin monomer is at least one C₂-C₈ alpha-olefin.

41. A process according to claim 37 wherein said at least one polymerizable olefin monomer is ethylene.

42. A process according to claim 37 wherein said at least one polymerizable olefin monomer is propylene.

43. A process according to claim 37 wherein said at least one polymerizable olefin monomer is a combination of at least two said monomers that are copolymerizable with each other.

44. A process according to claim 43 wherein one of said monomers is ethylene.

45. A process according to claim 43 wherein said combination is a combination of ethylene and at least one alpha-olefin that is copolymerizable with ethylene and that has in the range of about 5 to about 8 carbon atoms in the molecule.

46. A process according to any of claims 37, 38, 39, 40, 41, 42, 43, 44, or 45 wherein said heterogeneous catalyst composition has been prepolymerized with ethylene.
